(19) United States
(12) Patent Application Publication
(10) Pub. No.: US 2004/0247385 A1
(43) Pub. Date: Dec. 9, 2004

(54) Method for enhancing bolt fastening

(76) Inventors: Che-Kuei Mai, Hsinchu (TW); Lo Ming-Mo, Chu Tang Hsiang (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/803,158

(22) Filed: Mar. 18, 2004

(30) Foreign Application Priority Data
Mar. 21, 2003 (TW) 92106392

(51) Int. Cl. F16B 13/04

(52) U.S. Cl. 403/408.1

(57) ABSTRACT

A fastening method used to enhance frame fastening of LCD module. A plate is bent such that two layers of the plates are overlapped on a predetermined screw hole position. An adhesive material layer is disposed between the two adjacent layers of plates. At least one screw hole is forming by punching the predetermined screw hole position.

### BACKGROUND OF THE INVENTION

1. Field of Invention

The present invention relates to a method for enhancing bolt fastening. More particularly, the present invention relates to a method for enhancing bolt fastening of a frame for an LCD module.

2. Description of Related Art

One of the fastening methods for an LCD (Liquid Crystal Display, used in Notebook PC or Monitor) module uses bolts. FIG. 1A and FIG. 1B respectively illustrate two conventional bolt fastening methods for LCD module. Referring to FIG. 1A, a screw hole is formed by punching a plate 14 with a bolt 10 and a bump 18 is formed subsequently. Referring to FIG. 1B, a bolt 10 and a nut 16 are employed to fasten plates 12 & 14. A nut is not necessary to be used in the fastening method illustrated in FIG. 1A. No matter which method mentioned above is used, an effective thread length is critical to fastening.

Referring to FIG. 1A, a bump 18 is formed while punching the plate 14 and the thickness of the bump 18 determines the effective thread length (as illustrated in FIG. 1A). This method has its limitations in increasing the effective thread length since the thickness of the plate cannot be increased. That is, the thickness of the bump 18 is directly related to the thickness of the plate 14.

Alternatively, another method to increase the effective thread length is to add the nut 16 (as illustrated in FIG. 1B). Adding nuts may increase manufacturing cost and the weight of the LCD module, which is counterproductive as the trend to reduce the thickness of the plate to satisfy the requirements of thin and light notebook PCs and monitors.

For the forgoing reasons, there is a need for sustaining and improving bolt fastening while decreasing the thickness of a plate.

### SUMMARY OF THE INVENTION

It is therefore an objective of the present invention to provide a method for enhancing bolt fastening, so as to improve the fastening of a frame in an LCD module.

In accordance with the foregoing and other objectives of the present invention, a fastening method used to enhance frame fastening of an LCD module includes the following steps. A plate is bent such that two layers of the plates are overlapped on a predetermined screw hole position. An adhesive material layer is disposed between the two adjacent layers of plates. Punching the predetermined screw hole position forms at least one screw hole.

According to one embodiment of present invention, plate bending and punching screw hole are employed to increase the effective screw thread length. Two steps can be swapped in sequence.

In addition, the bolt fastening method of present invention can maintain similar fastening forces with a thinner plate. Thus, the overall weight of the LCD module can be reduced.

Thus, the bolt fastening method of present invention can decrease overall weight of an LCD module, increase fastening forces, and save manufacturing costs.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A, 1B respectively illustrate two conventional bolt fastening methods according to the prior art; and

FIGS. 2A, 2B, 2C, 2D respectively illustrate two bending and punching methods for the bolt fastening according to one embodiment of this invention;

FIG. 3 illustrates a perspective view of an LCD module bolt fastening according to another embodiment of this invention; and

FIGS. 4A, 4B respectively illustrate certain differences in fastening methods between the prior art and the present invention.

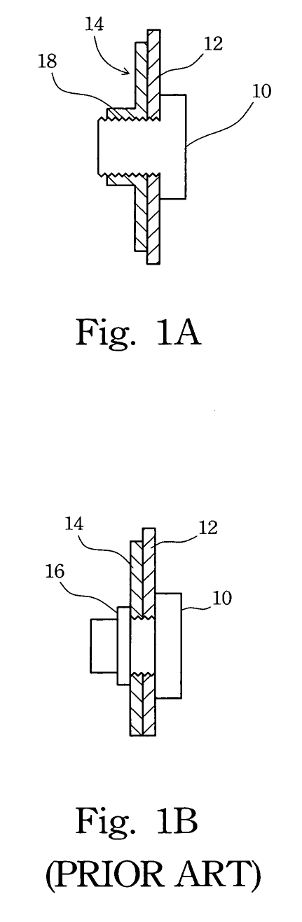

### DESCRIPTION OF THE PREFERRED EMBODIMENTS

Reference will now be made in detail to the present embodiments of the invention, examples of which are illustrated in the accompanying drawings. Wherever possible, the same reference numbers are used in the drawings and the description to refer to the same or like parts.

The method employed to increase the effective screw thread length is to increase the thickness at least two times in a predetermined screw hole position by bending a plate, such as a metal plate. In addition, an adhesive material layer is applied between two layers of plates. When a screw or a bolt is driven into a screw hole, the adhesive material layer attaches to the inner thread of the screw hole. Because the adhesive material layer increases the friction force against the screw, the bolt does not slip out of the screw hole easily.

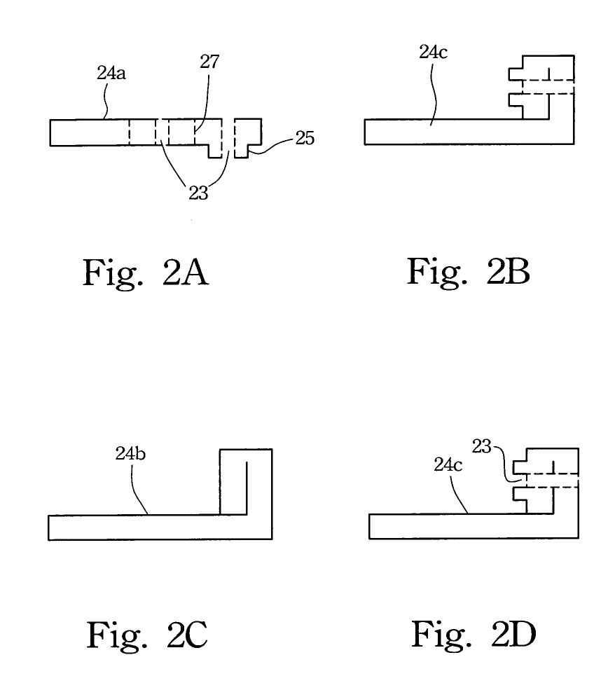

FIG. 2A illustrates a bending and punching method for the bolt fastening according to one embodiment of this invention. First, predetermined screw hole positions are located on a plate 24a, and a bending line 27 is marked on the plate 24a. Two precise screw hole positions 23 are located with reference to the bending line 27. Punching the precise screw hole positions forms two screw holes and one of two screw holes has a bump 25 for increasing the thickness of the plate. Next (as illustrated in FIG. 2B), the plate 24a is bent into the plate 24c along the bending line 27. Because the thickness of the plate 24c in a predetermined screw hole position is two times the thickness of the plate 24a in the predetermined screw hole position, the effective screw thread length is increased in the plate 24c.

Alternatively (as illustrated in FIG. 2C and FIG. 2D), predetermined screw hole positions are located on a plate, and a bending line is marked on the plate. First, the original plate 24a is bent into the plate 24b (as illustrated in FIG. 2C) along the bending line. Next, a screw hole 23 is formed by punching on the predetermined screw hole position (as illustrated in FIG. 2D). The two methods differ in the sequence of the plate bending and the screw hole punching. The purpose of the two methods remains the same, namely, to increase the effective screw thread length by increasing the thickness of the plate. Specifically, two layers of plates are illustrated in preferred embodiments of present invention, but three or more layers of plates are also permitted in application of the present invention.

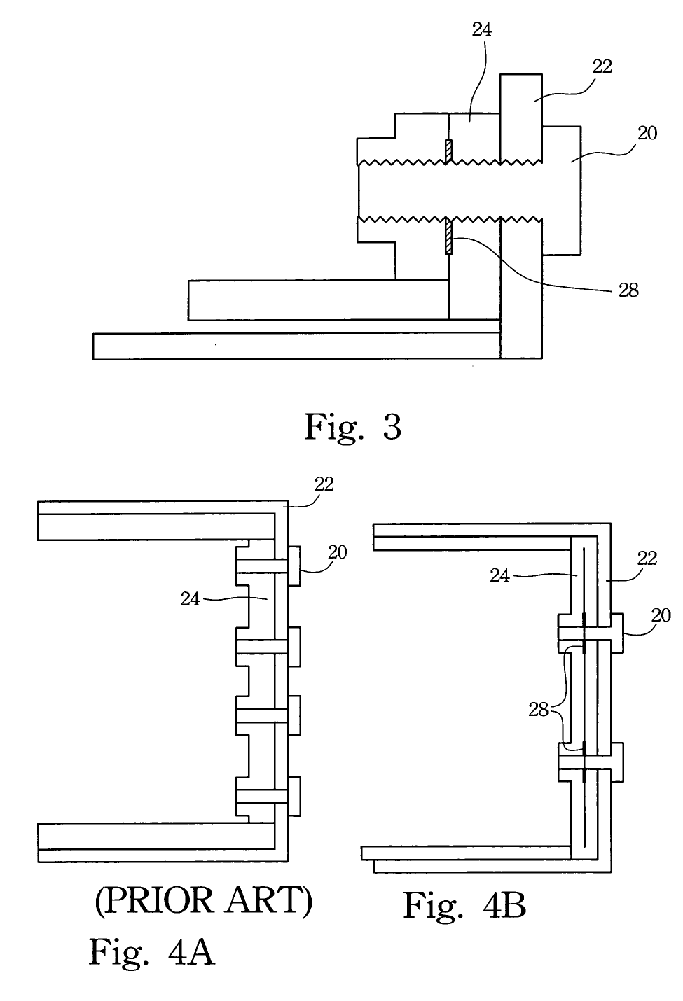

In order to decrease the chances of a bolt falling off, an adhesive layer is fills a gap between two adjacent layers of plate in addition to bending the plate and punching the screw hole. When a screw or a bolt is driven into a screw hole, the adhesive layer attaches to the inner thread of the screw hole. Because the adhesive layer increases the friction force against the screw, the bolt does not slip out of the screw hole easily. Referring to FIG. 3, adhesive layer 28, such as a adhesive material layer, a double-sided adhesive tape, a adhesive glue or plastic rings is applied between two layers of plates to enhance the friction forces between a bolt and a screw hole.

FIG. 4A, 4B respectively illustrate differences in fastening methods between the prior art and the present invention. The difference between FIG. 4A and FIG. 4B lies in that the whole plate thickness of FIG. 4B is half of all plate thickness of FIG. 4A except in the predetermined screw hole positions. The thickness of the plate in FIG. 4A and FIG. 4B in the predetermined screw hole positions is identical. In other words, the plates of FIG. 4A and FIG. 4B provide identical effective screw thread lengths. In addition, an adhesive material layer is added between two adjacent layers of plates in FIG. 4B to increase the friction force against the screw. Therefore, the bolt fastening method of present invention can reduce the numbers of screws and screw holes, but maintain the original fastening force. That is, the present invention can decrease the overall weight of the LCD module. For example, the plate's original thickness of a 14.1 inch LCD module is 0.3 mm (weight=21 kg). The plate can be shaped into a 14.1 inch LCD module with a 0.2 mm thickness (weight=16 kg) by application of the present invention. Besides, the 14.1 inch LCD module with a 0.2 mm thickness provides the same fastening as a 14.1 inch LCD module with a 0.3 mm thickness.

According to the embodiments of present inventions, the bolt fastening method of present invention can decrease overall weight of an LCD module, increase fastening forces, and save manufacturing costs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for enhancing bolt fastening, the method being employed to improve fastening of a plate of a LCD module, the steps of the method comprising:
bending the plate so as to overlap a plurality of layers of the plate in a predetermined screw hole position; and
forming at least one screw hole in the predetermined screw hole position.

2. The method of claim 1, wherein the predetermined screw hole position is located on an upper, lower, or side edge of a frame.

3. The method of claim 1, further comprising a fastening layer applied in a gap between said plurality of layers of the plate.

4. The method of claim 3, wherein the fastening layer is a double-sided adhesive tape, an adhesive material layer, adhesive glue or plastic rings.

5. The method of claim 1, wherein the screw hole is forming by punching.

6. A bolt fastening structure employed to improve fastening of a plate of an LCD module, the bolt fastening structure comprising:
a plurality of layers of an overlapped plate; and
at least one screw hole formed through said plurality of layers of plates.

7. The bolt fastening structure of claim 6, wherein said plurality of layers of said overlapped plate are formed by bending the plate.

8. The bolt fastening structure of claim 6, further comprising at least one adhesive material layer disposed between the said plurality of layers of the plate.

9. The bolt fastening structure of claim 8, wherein the adhesive material layer is a double-sided adhesive tape, an adhesive material layer, adhesive glue or plastic rings.

10. The bolt fastening structure of claim 6, wherein the screw hole is forming by punching the plurality of layers of the overlapped plate.

11. The bolt fastening structure of claim 6, wherein the plate is a metal plate.
